(19) United States
(12) Patent Application Publication
(10) Pub. No.: US 2025/0282113 A1
(43) Pub. Date: Sep. 11, 2025

(54) REPAIR SHEET AND TIRE REPAIRING METHOD

(71) Applicant: SUMITOMO RUBBER INDUSTRIES, LTD., Kobe-shi, Hyogo (JP)

(72) Inventor: Saki MUTO, Kobe-shi (JP)

(73) Assignee: SUMITOMO RUBBER INDUSTRIES, LTD., Kobe-shi, Hyogo (JP)

(21) Appl. No.: 18/715,332

(22) PCT Filed: Nov. 28, 2022
(86) PCT No.: PCT/JP2022/043780

§ 371 Date: Oct. 28, 2024

(30) Foreign Application Priority Data
Dec. 1, 2021 (JP) 2021-195446

(51) Int. Cl. B29D 30/54

(52) U.S. Cl. CPC B29D 30/54

(57) ABSTRACT

It is an object of the present disclosure to allow for providing a repair sheet that can process a tire with less effort and a tire repairing method.

5 Provided is a repair sheet to be attached to a tire part, the repair sheet comprising a retaining layer capable of retaining an additive to be supplied into the tire part, wherein the retaining layer has a breaking strength of 0.5 MPa or more and a breaking elongation of 5% or more.

### TECHNICAL FIELD

The present disclosure relates to a repair sheet and a tire repairing method.

### BACKGROUND ART

Conventionally, for a tire whose tire rubber has reached the end of its useful life, for example, a tire whose tread part has reached the end of its useful life, a processing method of removing an old tread part and then replacing it with a new tread rubber has been known (Patent Document 1).

### PRIOR ART DOCUMENT

### Patent Document

Patent Document 1: JP 2018-114781 A

### SUMMARY OF THE INVENTION

### Problem to be Solved by the Invention

However, in the conventional processing method, operations such as, for example, removing a tread part and attaching a new one, etc. are required, and therefore, such processing has required time and effort.

It is an object of the present disclosure to provide a repair sheet and a tire repairing method.

### Means to Solve the Problem

The present disclosure relates to a repair sheet to be attached to a tire part, the repair sheet comprising
a retaining layer capable of retaining an additive to be supplied into the tire part,
wherein the retaining layer has a breaking strength of 0.5 MPa or more and a breaking elongation of 5% or more.

### Effect of the Invention

According to the present disclosure, a repair sheet that can process a tire with less effort and a tire repairing method can be provided.

### EMBODIMENT FOR CARRYING OUT THE INVENTION

The repair sheet relating to the present disclosure is a repair sheet to be attached to a tire part, the repair sheet comprising a retaining layer capable of retaining an additive to be supplied into the tire part, wherein the retaining layer has a breaking strength of 0.5 MPa or more and a breaking elongation of 5% or more.

According to this construction, since the repair sheet has a breaking strength of a predetermined value or more, it is less likely to break during its use, and furthermore, since it has a breaking elongation of a predetermined value or more, it is easily allowed to follow the tire part during its use. Therefore, it is easy to handle. Accordingly, a tire can be processed with less effort. Moreover, an amount of an additive to be supplied can be adjusted by a repairing time for which the repair sheet retaining the additive is brought into contact with the tire, as well as by an amount of an additive retained in the repair sheet. Besides, the physical properties of the retaining layer having a breaking strength of 0.5 MPa or more and a breaking elongation of 5% or more are values in a state where no additive is retained in the retaining layer. Furthermore, “repair” in the present disclosure not only refers to tire processing for improving or maintaining performances of a used tire, but also means to include tire processing for improving or modifying performances of a new tire.

The retaining layer is preferably composed of a material comprising at least one selected from the group consisting of a thermoplastic elastomer, a resin, and a crosslinked rubber. This is because it becomes easy to obtain a predetermined retaining layer according to the present disclosure.

A thickness of the retaining layer is preferably 100 mm or less. This is because, if the retaining layer becomes too thick, handling becomes difficult.

It is preferable that the repair sheet further comprises a supporting layer that supports the retaining layer. This is because the repair sheet becomes easy to be handled by further comprising a supporting layer.

The repair sheet of the present disclosure is used for processing a tire with an additive retained in the retaining layer. The additive preferably comprises at least one selected from the group consisting of a plasticizing agent, an antioxidant, and a vulcanization accelerator.

Another embodiment of the present disclosure is a tire repairing method, the method comprising the steps of attaching the repair sheet to a tire part and supplying the additive into the tire part.

When the repair sheet is attached to the tread part of the tire, it is preferable that the retaining layer has a vertical length equal to or less than a tire width plus 10 mm, a lateral length equal to or less than a tire periphery plus 10 mm, and a thickness of 110 mm or less.

### Definition

### (Tire Part)

A tire part is a term used for specifying a position, on a surface including an outer surface or inner surface of the tire, of a tire member that constitutes the surface, for example, a tread part, a sidewall part, a clinch part, a wing part, an inner liner part, etc., but it is not limited to them as long as the position of the tire member on the surface can be specified.

### Measuring Method

### (Content of Additive Inside Tire Tread)

A content of an additive is determined as an amount of an extract by immersing a sample cut out from a tread surface of each tire in acetone for 24 hours to extract a soluble component and measuring masses of each sample before and after extraction, according to JIS K 6229, with the following equation:

Amount of extract (%)={(mass of sample before extraction−mass of sample after extraction)/(mass of sample before extraction)}×100.

### (Hardness of Tire Tread)

Hardness is measured by pressing a type A durometer against the sample at 23° C. in accordance with JIS K 6253.

### (Breaking Strength and Breaking Elongation of Retaining Layer)

A breaking strength TB, in MPa, and a breaking elongation EB, in %, are measured by performing a tensile test for a dumbbell-shaped No. 7 test piece with a thickness of 1 mm under a condition of a tensile speed of 3.3 mm/sec in an atmosphere of 23° C., according to JIS K 6251 “Rubber, vulcanized or thermoplastics-Determination of tensile stress-strain properties”.

### (Ozone Resistance of Tire Tread)

Ozone resistance is evaluated by preparing a test piece of a predetermined size from a surface of a tread part and performing a dynamic ozone deterioration test for this test piece, in accordance with JIS K 6259 “Rubber, vulcanized or thermoplastics-Determination of ozone resistance”. Specifically, a test of imparting with 48 hours of reciprocating motion at a frequency of 0.5±0.025 Hz for the test piece is performed under a condition of an ozone concentration of 50±5 pphm, a test temperature at 40° C., and a tensile strain of 10±2%, and after the test, states of cracks (presence or absence of cracks, number of cracks, lengths of cracks, etc.) generated on the test piece are observed. As an evaluation method, the method described in JIS K 6259 (Procedure A: Crack condition observation procedure) is used. Specifically, a numerical value indicating a degree of crack generation defined by multiplying the number of cracks of 0.05 mm or more confirmed after the test by an average length of cracks of 0.05 mm or more in length is calculated, and an inverse value of the numerical value is used as an evaluation value of an ozone resistance index.

(Weight-Average Molecular Weight of Various Materials used for Repair Sheet)

A “weight-average molecular weight” can be calculated in terms of a standard polystyrene based on measurement values obtained by a gel permeation chromatography (GPC) (e.g., GPC-8000 Series manufactured by Tosoh Corporation, detector: differential refractometer, column: TSKGEL SUPERMULTIPORE HZ-M manufactured by Tosoh Corporation).

### (Tensile Strength of Resin)

“Tensile strength, in MPa, of resin” can be determined as tensile strength (50 mm/min) according to ISO 527-1.

### Repair Sheet

The repair sheet of the present disclosure will be described below.

### <Retaining Layer>

A retaining layer is capable of retaining an additive, and has a breaking strength of 0.5 MPa or more and a breaking elongation of 5% or more. These values are physical properties of a retaining layer in a state where no additive is retained. It is preferable that a retaining layer in a state where an additive is retained (the entire layer consisting of a retaining layer and an additive retained in the retaining layer) also satisfies these physical properties.

### (Breaking Strength)

Breaking strength, in MPa, of a retaining layer is preferably greater than 0.5, more preferably greater than 1.0, further preferably greater than 1.5, further preferably greater than 2.0, further preferably 3.0 or more, further preferably greater than 5.0, further preferably greater than 10.0, further preferably greater than 15.0, further preferably 17.0 or more, from the viewpoint of securing strength during use. On the other hand, there is no particular upper limit for breaking strength, in MPa, from the viewpoint of securing strength during use, but the upper limit is usually about less than 40.0, or may be less than 35.0, less than 30.0, less than 25.0, or less than 20.0. These values are physical properties of a retaining layer in a state where no additive is retained. It is preferable that a retaining layer in a state where an additive is retained (the entire layer consisting of a retaining layer and an additive retained in the retaining layer) also satisfies these physical properties.

### (Breaking Elongation)

Breaking elongation, in %, of a retaining layer is preferably greater than 5, more preferably greater than 10, further preferably greater than 50, further preferably greater than 100, further preferably greater than 200, further preferably 230 or more, further preferably greater than 300, further preferably greater than 400, further preferably 420 or more, further preferably greater than 500, further preferably greater than 600, from the viewpoint of securing followability during use. On the other hand, there is no particular upper limit for breaking elongation, in %, from the viewpoint of securing followability during use, but the upper limit is usually about less than 1200, or may be less than 1100, less than 1000, less than 900, or less than 800. These values are physical properties of a retaining layer in a state where no additive is retained. It is preferable that a retaining layer in a state where an additive is retained (the entire layer consisting of a retaining layer and an additive retained in the retaining layer) also satisfies these physical properties.

### (Size)

A thickness of a retaining layer is preferably 100 mm or less, more preferably 80 mm or less, further preferably 60 mm or less, further preferably 50 mm or less, from the viewpoint of ease of handling. On the other hand, a lower limit of the thickness is not particularly limited as long as a necessary amount of an additive can be retained, but usually, it is preferably 0.5 mm or more, more preferably 0.8 mm or more, further preferably 1 mm or more. These values are dimensions of a retaining layer in a state where no additive is retained. It is preferable that a retaining layer in a state where an additive is retained (the entire layer consisting of a retaining layer and an additive retained in the retaining layer) also satisfies these dimensions.

In a case of a repair sheet intended to be attached to a tire tread, a length of a retaining layer in a tire width direction (vertical) is preferably equal to or less than a length in tire width. Moreover, a length of a retaining layer in a tire circumferential direction (lateral) is preferably equal to or less than a length in tire periphery.

### (Retention of Additive)

A ratio, in % by mass, of a mass of an additive retained by a retaining layer to a total amount of a mass of the retaining layer and the mass of the additive is preferably greater than 0.1% by mass, more preferably greater than 15% by mass, further preferably greater than 25% by mass. On the other hand, there is no particular upper limit for the ratio in % by mass, but the upper limit is usually less than 99.9% by mass, less than 92% by mass, or less than 90% by mass.

In the case of the repair sheet intended to be attached to the tire tread, a thickness of a retaining layer retaining an additive is preferably 110 mm or less, more preferably 88 mm or less, further preferably 66 mm or less, further preferably is 55 mm or less. On the other hand, a lower limit of the thickness is not particularly limited, but usually, it is preferably 0.55 mm or more, more preferably 0.88 mm or more, further preferably 1.1 mm or more. Moreover, a vertical length of the retaining layer is preferably equal to or less than a length in tire width plus 10 mm. Furthermore, a lateral length of the retaining layer is preferably equal to or less than a length in tire periphery plus 10 mm.

### <Material of Retaining Layer>

A material of a retaining layer is not particularly limited as long as it can retain an additive and has predetermined breaking strength and breaking elongation, as described above. Examples of such a material include, for example, a thermoplastic elastomer, a resin, a crosslinked rubber, and the like.

As a material constituting a retaining layer, one or two or more types thereof are preferably used. Besides, there is a case where a resin is used as a material of a retaining layer, and there is another case where a resin is used as an additive, and therefore, the resin as the material of the retaining layer shall be referred to as a first resin, and the resin as the material of the additive shall be referred to as a second resin, in the following.

### (Thermoplastic Elastomer)

A thermoplastic elastomer used as a material of a retaining layer is not limited as long as it can retain an additive and form a retaining layer that can be deformed and attached along a shape of a tire, satisfying predetermined requirements such as for breaking strength and the like. Examples of the thermoplastic elastomer include, for example, a styrene-based elastomer, a polyurethane-based elastomer, a polyester-based elastomer, and the like. Among them, a styrene-based elastomer is preferable. The thermoplastic elastomer can be used alone, or two or more thereof can be used in combination.

As the styrene-based elastomer, a styrene block-containing thermoplastic elastomer can be appropriately used. The styrene block-containing thermoplastic elastomer comprises a hard segment of a polystyrene block and a soft segment. A typical soft segment is a diene block. Examples of a constituent component of the diene block include butadiene, isoprene, 1,3-pentadiene, and 2,3-dimethyl-1,3-butadiene, and among them, butadiene and isoprene are preferable. One or more constituent components can be used as constituent components of the diene block.

The styrene block-containing thermoplastic elastomer comprises a styrene-butadiene-styrene block copolymer (SBS), a styrene-isoprene-styrene block copolymer (SIS), a styrene-isobutylene-styrene block copolymer (SIBS), a hydrogenated product of SBS, a hydrogenated product of SIS, and a hydrogenated product of SIBS. Examples of the hydrogenated product of SBS include a styrene-ethylene-butylene-styrene block copolymer (SEBS) and a styrene-butadiene-butylene-styrene block copolymer (SBBS). Examples of the hydrogenated product of SIS include a styrene-ethylene-propylene-styrene block copolymer (SEPS). Among them, a SEBS is preferable.

A content of a styrene component in the styrene block-containing thermoplastic elastomer is preferably greater than 10% by mass, more preferably greater than 12% by mass, further preferably greater than 15% by mass, from the viewpoint of obtaining a retaining layer of the present disclosure. From the same viewpoint, this content is preferably less than 50% by mass, more preferably less than 47% by mass, further preferably less than 45% by mass.

Examples of the polyurethane-based elastomer include a thermoplastic elastomer having a plurality of urethane bonds in a main chain of a molecule. The polyurethane is preferably one obtained by reacting a polyisocyanate component and a polyol component. Examples of the polyisocyanate component include diphenylmethane diisocyanate (MDI), hexamethylene diisocyanate (HMDI), and the like.

As the polyester-based thermoplastic elastomer, those having a soft segment of an olefin-based elastomer and a hard segment of polyethylene terephthalate, polybutylene terephthalate, or the like are appropriately used. Examples of the olefin-based elastomer include those obtained by homopolymerizing one selected from the group consisting of a linear alkene having 1 to 8 carbon atoms, a branched alkene, and polyvinyl acetate, or copolymerizing two or more of them, specifically an ethylene-vinyl acetate copolymer, an ethylene-propylene copolymer, a linear low-density polyethylene, and the like.

### (First Resin)

A first resin used as a material of a retaining layer is not limited as long as it can retain an additive and form a retaining layer that can be deformed and attached along a shape of a tire, satisfying predetermined requirements such as breaking strength and the like. As such a first resin, those commonly used in the plastic or tire industry can be used. The first resin is solid at 25° C. A softening temperature of the first resin is preferably higher than 60° C., more preferably higher than 70° C., further preferably higher than 80° C. The softening temperature of the first resin is a value (so-called a Vicat softening temperature) measured by A50 method according to JIS K7206 (test load: 10N, temperature rising rate: 50° C./h). Examples of the first resin include, for example, an alkylphenol-based resin, a coumarone indene resin, a terpene-based resin, a styrene-based resin, a rosin-based resin, an acryl-based resin, a dicyclopentadiene resin (DCPD resin), and the like. Among them, a styrene-based resin is preferable. Examples of the styrene-based resin include a resin that is a homopolymer of a-methylstyrene or styrene, a resin that is a copolymer of at least one of a-methylstyrene and styrene and butadiene, and the like. Among them, a styrene-butadiene copolymer resin and the like are preferable. The first resin may be used alone, or two or more thereof may be used in combination.

As the alkylphenol-based resin, for example, those manufactured by BASF and Taoka Chemical Co., Ltd., and the like can be used. As the coumarone indene resin, for example, those manufactured by NIPPON STEEL Chemical & Material Co., Ltd. and ENEOS Corporation, and the like can be used. As the terpene-based resin, for example, those manufactured by Kraton Corporation and Yasuhara Chemical Co., Ltd., and the like can be used. As the styrene-based resin, for example, those manufactured by Asahi Kasei Corporation and Kraton Corporation, and the like can be used. As the rosin-based resin, for example, those manufactured by Harima Chemicals Group, Inc. and Arakawa Chemical Industries, Ltd., and the like can be used.

A tensile strength, in MPa, of the first resin is preferably 5 or more, more preferably 10 or more, further preferably 15 or more, from the viewpoint of effects of the present disclosure. Moreover, there is no particular upper limit for the tensile strength, but it is usually about 50 or less, or about 40 or less. The tensile strength, in MPa, of the first resin is measured by a method of measuring tensile strength of the resins as described above.

### (Crosslinked Rubber)

A crosslinked rubber used as a material of a retaining layer is not limited as long as it can retain an additive and form a retaining layer that can be deformed and attached along a shape of a tire, satisfying predetermined requirements such as breaking strength and the like. Here, the crosslinked rubber refers to a rubber in which chain rubber molecules are crosslinked to each other to form a three-dimensional network structure so as to prevent plastic deformation.

As a rubber component constituting a crosslinked rubber, a crosslinkable rubber component commonly used in the tire industry can be used, examples of which include an isoprene-based rubber such as a natural rubber (NR), an isoprene rubber (IR), and the like, a styrene-butadiene rubber (SBR), a butadiene rubber (BR), a styrene-isoprene-butadiene copolymer rubber (SIBR), a chloroprene rubber (CR), an acrylonitrile-butadiene rubber (NBR), a butyl rubber (IIR), an ethylene propylene rubber, a polynorbornene rubber, a silicone rubber, a chlorinated polyethylene rubber, a hydrin rubber, and the like. The rubber component may be used alone, or two or more thereof may be used in combination.

More specifically, for example, the NR is not particularly limited, and those commonly used in the tire industry can be used, such as SIR20, RSS #3, TSR20, and the like. The SBR is not particularly limited, and those commonly used in the tire industry can be used, any of an emulsion polymerized styrene-butadiene rubber (E-SBR) and a solution polymerized styrene-butadiene rubber (S-SBR) can be used, and those manufactured and sold by JSR Corporation, Sumitomo Chemical Co., Ltd., Ube Industries, Ltd., Asahi Kasei Corporation, ZS Elastomer Co., Ltd., etc. can be used. The BR is not particularly limited, and those commonly used in the tire industry can be used, and those manufactured and sold by JSR Corporation, Zeon Corporation, Ube Industries, Ltd., etc. can be used.

### <Additive>

An additive is, among additives added to a rubber composition constituting a tire, an additive that has its own property of penetrating into the rubber composition to soften the rubber composition, or an additive, if it does not have its own property of penetrating into the rubber composition, used in combination with an additive having a property of penetrating the rubber composition to soften it. The additive preferably comprises at least one selected from the group consisting of a plasticizing agent, an antioxidant, and a vulcanization accelerator. In the present disclosure, the additive is supplied into a rubber composition constituting a tire part and penetrates into the tire part by preferably 0.1 mm or more, more preferably 1 mm or more, further preferably 2 mm or more.

### (Plasticizing Agent)

Examples of the plasticizing agent include, for example, oil, a resin (second resin), a liquid rubber, an ester-based plasticizing agent, and the like.

Among them, oil, a second resin, and an ester-based plasticizing agent are preferable. As the additive, among these plasticizing agents, it is preferable to use one that is liquid at a normal temperature (25° C.) or use an additive in combination with a liquid one. The plasticizing agent may be used alone, or two or more thereof may be used in combination.

### <<Oil>>

Examples of oil include, for example, a mineral oil, a vegetable oil (or fat), or mixtures thereof. Examples of the mineral oil include, for example, a paraffin oil, an aroma-based oil, a naphthenic oil, and the like. Examples of the vegetable oil (or fat) include a castor oil, a cottonseed oil, a linseed oil, a rapeseed oil, a soybean oil, a palm oil, a coconut oil, a peanut oil, rosin, a pine oil, pine tar, a tall oil, a corn oil, a rice oil, a safflower oil, a sesame oil, an olive oil, a sunflower oil, a palm kernel oil, a camellia oil, a jojoba oil, a macadamia nut oil, a tung oil, and the like. They may be used alone, or two or more thereof may be used in combination.

### <<Second Resin>>

The second resin is not particularly limited, examples of which include a petroleum resin, a terpene-based resin, a rosin-based resin, a phenol-based resin, and the like, which are commonly used in the tire industry. Among them, a petroleum resin is preferable. The second resin may be used alone, or two or more thereof may be used in combination. Besides, when the first resin is used as a material of a retaining layer, a second resin as a plasticizing agent, which is a different type of resin from the first resin, is selected.

Examples of the petroleum resin include a C5-based petroleum resin, an aromatic petroleum resin, a C5-C9-based petroleum resin, and the like. Among them, an aromatic petroleum resin is preferable.

The “C5-based petroleum resin” refers to a resin obtained by polymerizing a C5 fraction. Examples of the C5 fraction include, for example, a petroleum fraction having 4 to 5 carbon atoms such as cyclopentadiene, a pentene, a pentadiene, isoprene, and the like. As the C5-based petroleum resin, a dicyclopentadiene resin (DCPD resin) is appropriately used.

The “aromatic petroleum resin” refers to a resin obtained by polymerizing a C9 fraction, and may be hydrogenated or modified. Examples of the C9 fraction include, for example, a petroleum fraction having 8 to 10 carbon atoms such as vinyltoluene, alkylstyrene, indene, methylindene, and the like. As specific examples of the aromatic petroleum resin, for example, a coumarone indene resin and an aromatic vinyl-based resin are appropriately used. Among them, a coumarone indene resin is preferable. As the aromatic vinyl-based resin, a homopolymer of a-methylstyrene or styrene or a copolymer of a-methylstyrene and styrene is preferable, and a copolymer of a-methylstyrene and styrene is more preferable, because it is economical, easy to process, and excellent in heat generation. As the aromatic vinyl-based resin, for example, those commercially available from Kraton Corporation, Eastman Chemical Company, etc. can be used.

The “C5-C9-based petroleum resin” refers to a resin obtained by copolymerizing the C5 fraction and the C9 fraction, and may be hydrogenated or modified. Examples of the C5 fraction and the C9 fraction include the above-described petroleum fractions. As the C5-C9-based petroleum resin, for example, those commercially available from Tosoh Corporation, Luhua Co., Ltd, etc. can be appropriately used.

Examples of the terpene-based resin include a polyterpene resin consisting of at least one selected from terpene compounds such as a-pinene, B-pinene, limonene, a dipentene, and the like; an aromatic-modified terpene resin made from a terpene compound of the above-described terpene compounds and an aromatic compound; a terpene phenolic resin made from a terpene compound and a phenol-based compound; and those in which these terpene-based resins are hydrogenated (hydrogenated terpene-based resins). Examples of the aromatic compound used as a raw material for the aromatic-modified terpene resin include, for example, styrene, a-methylstyrene, vinyltoluene, a divinyltoluene, and the like. Examples of the phenol-based compound used as a raw material for the terpene phenolic resin include, for example, phenol, bisphenol A, cresol, xylenol, and the like.

Examples of the rosin-based resin include natural resin rosins such as tall rosin, gum rosin, and wood rosin, rosin-modified resins obtained by modifying them by hydrogenation, disproportionation, dimerization, esterification, etc., and the like.

Examples of the phenol-based resin include a phenol formaldehyde resin, an alkylphenol formaldehyde resin, an alkylphenol acetylene resin, an oil-modified phenol formaldehyde resin, and the like.

A softening point of the second resin is not particularly limited, but the second resin is easily added when it has a low softening point and is liquid, which is preferable. Therefore, when also considering such a viewpoint, the softening point of the second resin is usually preferably higher than 0° C., more preferably higher than 5° C., further preferably higher than 10° C. Moreover, the softening point of the second resin is preferably lower than 150° C., more preferably lower than 140° C., further preferably lower than 130° C., further preferably less than 80° C., further preferably less than 50° C., further preferably less than 25° C., further preferably less than 20° C. Besides, a softening point in the present specification can be defined as a temperature at which a sphere drops when the softening point specified in JIS K 6220-1:2001 is measured with a ring and ball softening point measuring device. Furthermore, a molecular weight (Mw) of the second resin is preferably 300 or more, and preferably less than 10,000.

### <<Liquid Rubber>>

The liquid rubber is not particularly limited as long as it is a polymer in a liquid state at a normal temperature (25° C.), examples of which include, for example, a diene-based polymer having a weight-average molecular weight of 50,000 or less, more preferably 10,000 or less, more specifically a liquid butadiene rubber (a liquid BR), a liquid styrene-butadiene rubber (a liquid SBR), a liquid isoprene rubber (a liquid IR), a liquid styrene-isoprene rubber (a liquid SIR), a liquid farnesene rubber, and the like. The liquid rubber may be used alone, or two or more thereof may be used in combination.

### <<Ester-Based Plasticizing Agent>>

Examples of the ester-based plasticizing agent include, for example, dibutyl adipate (DBA), diisobutyl adipate (DIBA), dioctyl adipate (DOA), bis (2-ethylhexyl) azelate (DOZ), dibutyl sebacate (DBS), diisononyl adipate (DINA), diethyl phthalate (DEP), dioctyl phthalate (DOP), diundecyl phthalate (DUP), dibutyl phthalate (DBP), dioctyl sebacate (DOS), tributyl phosphate (TBP), trioctyl phosphate (TOP), triethyl phosphate (TEP), trimethyl phosphate (TMP), thymidine triphosphate (TTP), tricresyl phosphate (TCP), trixylenyl phosphate (TXP), and the like. The ester-based plasticizing agent may be used alone, or two or more thereof may be used in combination.

### (Antioxidant)

Examples of the antioxidant include, for example, a naphthylamine-based antioxidant such as phenyl-a-naphthylamine and the like; a diphenylamine-based antioxidant such as an octylated diphenylamine, 4,4′-bis(α,α′-dimethylbenzyl)diphenylamine, and the like; p-phenylenediamine-based antioxidant such as N-isopropyl-N′-phenyl-p-phenylenediamine, N-(1,3-dimethylbutyl)-N′-phenyl-p-phenylenediamine, N,N′-di-2-naphthyl-p-phenylenediamine, and the like; a quinoline-based antioxidant such as a polymer of 2,2,4-trimethyl-1,2-dihydroquinoline and the like; a monophenol-based antioxidant such as 2,6-di-t-butyl-4-methylphenol, a styrenated phenol, and the like; bis-, tris-, or polyphenol-based antioxidants such as tetrakis-[methylene-3-(3′,5′-di-t-butyl-4′-hydroxyphenyl)propionate]-methane and the like. As commercially available products, for example, products manufactured by Seiko Chemical Co., Ltd., Sumitomo Chemical Co., Ltd., Ouchi Shinko Chemical Industry Co., Ltd., Flexsys, etc. can be used. The antioxidant may be used alone, or two or more thereof may be used in combination.

### (Vulcanization Accelerator)

Examples of the vulcanization accelerator include, for example, sulfenamide-based, thiazole-based, thiuram-based, thiourea-based, guanidine-based, dithiocarbamic acid-based, aldehyde-amine-based or aldehyde-ammonia-based, imidazoline-based, and xantate-based vulcanization accelerators.

Examples of the sulfenamide-based vulcanization accelerator include CBS (N-cyclohexyl-2-benzothiazolylsulfenamide), TBBS (N-t-butyl-2-benzothiazolylsulfenamide), N-oxyethylene-2-benzothiazolylsulfenamide, N,N′-diisopropyl-2-benzothiazolylsulfenamide, N,N-dicyclohexyl-2-benzothiazolylsulfenamide, and the like. Examples of the thiazole-based vulcanization accelerator include 2-mercaptobenzothiazole, dibenzothiazolyldisulfide, and the like. Examples of the thiuram-based vulcanization accelerator include tetramethylthiuram monosulfide, tetramethylthiuram disulfide, tetrabenzylthiuram disulfide (TBzTD), and the like. Examples of the guanidine-based vulcanization accelerator include diphenylguanidine (DPG), diorthotrilguanidine, orthotrilbiguanidine, and the like. They may be used alone, or two or more thereof may be used in combination. Other additives may be materials commonly used for a tire.

Examples of other additives include, for example, a wax, a surfactant, vulcanization-based chemicals other than the above-described vulcanization accelerators, and the like.

### <Repair Sheet>

Examples of the repair sheet intended for the present disclosure include those comprising a retaining layer in a state where it does not retain the above-described additives, and those comprising a retaining layer in a state where it retains the above-described additives. In processing a tire with the repair sheet, the additives are retained in the retaining layer. Retention of an additive into the retaining layer may be configured so that the retaining layer in a state where it does not retain the additive is impregnated or injected with the additive, or the like, making the retaining layer into a state where it retains the additive, or that the additive is retained in the process of preparing the retaining layer.

The repair sheet of the present disclosure is preferably used to be attached directly to an externally exposed part of a tire part, such as, for example, a tread part, a sidewall part, a clinch part, and a wing part on the outer surface, an inner liner part on the inner surface, and the like. In this case, since the repair sheet of the present disclosure has predetermined breaking strength and breaking elongation, it can be efficiently attached to the tire. Moreover, an amount of an additive to be supplied to the tire can be adjusted by a time for which the repair sheet retaining the additive is brought into contact with the tire, i.e., a repairing time, as well as by an amount of an additive retained in the repair sheet. Accordingly, the tire can be processed with less effort.

The repair sheet of the present disclosure preferably has a shape and a size necessary and sufficient to cover the tire part. For example, when the repair sheet of the present disclosure is used to repair the tread, it is preferable that the repair sheet has a vertical length equal to or less than a tire width plus 10 mm, a lateral length equal to or less than a tire periphery plus 10 mm, and a thickness of 110 mm or less. Those skilled in the art can determine necessary and sufficient shape and size of the repair sheet of the present disclosure depending on a shape and a size of the tire part. (Supporting layer)

The repair sheet of the present disclosure may have a supporting layer that supports a retaining layer. When the repair sheet comprises the supporting layer, an advantage that the repair sheet has become easy to be handled until a retaining layer retaining an additive is attached to the tire can be obtained. The supporting layer is preferably one that does not inhibit deformation of the retaining layer when the repair sheet is attached to the tire, examples of which include, for example, one composed of a material (such as a rubber, a thermoplastic elastomer, and the like) that stretches more easily than the retaining layer.

### <Producing Method>

A method of producing a repair sheet of the present disclosure will be described below.

### (Retaining Layer)

A retaining layer that the repair sheet comprises can be produced by molding a predetermined material so that it can retain an additive and has predetermined breaking strength and breaking elongation. Those skilled in the art can select such a predetermined material and appropriately set a condition for molding the selected material.

### <<Retaining Layer Made of Thermoplastic Elastomer>>

A retaining layer made of a thermoplastic elastomer (base material) can be produced, for example, by press-molding a material comprising a pelletized thermoplastic elastomer. A pressure, a time, and a temperature for press molding can be appropriately set in a suitable combination depending on a type of a thermoplastic elastomer. Usually, a pressure (unit: MPa) for press molding is preferably greater than 0.1, more preferably greater than 0.2, further preferably greater than 0.4. On the other hand, the pressure is preferably less than 30, more preferably less than 25, further preferably less than 20. A time for press molding time is preferably greater than 1 minute, more preferably greater than 2 minutes, further preferably greater than 3 minutes. On the other hand, the time is preferably less than 20 minutes, more preferably less than 15 minutes, further preferably less than 10 minutes. A temperature for press molding can be appropriately set depending on a type of a thermoplastic elastomer used.

In the above, breaking strength of a retaining layer can be adjusted by selecting a type of a thermoplastic elastomer used, as well as by previously kneading a thermoplastic elastomer with materials other than the additives of the present disclosure, for example, reinforcing materials that do not penetrate into a tire such as carbon black, silica, and the like. For example, breaking strength can be increased by kneading a larger amount of reinforcing materials, and conversely, it can be decreased by kneading a smaller amount of reinforcing materials. Kneading of reinforcing materials into materials constituting a retaining layer can be performed using a Banbury mixer or the like. Besides, as described above, when materials other than the additives (for example, reinforcing materials) are used as materials of a retaining layer, the materials (reinforcing materials) can be regarded as components of the retaining layer (the same applies hereinafter).

Breaking elongation of a retaining layer can be adjusted by selecting a type of a thermoplastic elastomer used, as well as by previously kneading a thermoplastic elastomer with materials other than the additives of the present disclosure, for example, reinforcing materials that do not penetrate into a tire such as carbon black, silica, and the like.

### <<Retaining Layer Made of First Resin>>

A retaining layer made of a first resin (base material) can be produced, for example, by press-molding a material comprising a pelletized first resin. A pressure, a time, and a temperature for press molding can be appropriately set in a suitable combination depending on a type of a first resin. Usually, a pressure (unit: MPa) for press molding is preferably greater than 0.1, more preferably greater than 0.2, further preferably greater than 0.4. On the other hand, the pressure is preferably less than 30, more preferably less than 25, further preferably less than 20. A time for press molding time is preferably greater than 1 minute, more preferably greater than 2 minutes, further preferably greater than 3 minutes. On the other hand, the time is preferably less than 20 minutes, more preferably less than 15 minutes, further preferably less than 10 minutes. A temperature for press molding can be appropriately set depending on a type of a first resin used.

In the above, breaking strength of a retaining layer can be adjusted by selecting a type of a first resin used. For example, breaking strength can be increased by using a first resin having a larger strength such as tensile strength and the like, and conversely, it can be decreased by using a first resin having a smaller strength.

Breaking elongation of a retaining layer can be adjusted by selecting a type of a first resin used, as well as by previously kneading a first resin with materials other than the additives of the present disclosure, for example, reinforcing materials that do not penetrate into a tire such as carbon black, silica, and the like.

### <<Retaining Layer Made of Crosslinked Rubber>>

A retaining layer made of a crosslinked rubber (base material) can be produced, for example, by crosslinking a chain rubber molecule with a co-crosslinking agent, an organic peroxide, sulfur, or the like.

In the above, breaking strength of a retaining layer can be increased by making a crosslinking denser, as well as by previously kneading a crosslinked rubber with materials other than the additives of the present disclosure, for example, reinforcing materials that do not penetrate into a tire such as carbon black, silica, and the like. On the contrary, breaking strength can be decreased by making the crosslinking sparser, as well as by reducing an amount of the reinforcing materials to be kneaded.

Even if the material of the retaining layer (base material) is made of a combination of two or more selected from a thermoplastic elastomer, a first resin, and a crosslinked rubber, an intended retaining layer can be produced with reference to a producing method when using the above-described various materials as appropriate.

### (Repair Sheet Retaining Additive)

Retention of an additive into a retaining layer can be performed by immersing the retaining layer in the additive or injecting the additive into the retaining layer. The additive may be added at a room temperature or at a heated temperature within a range that does not affect a structure or function of the retaining layer. Alternatively, after mixing the material of the retaining layer (base material) and the additive, press molding may be performed as in the above-described producing method. However, it is preferable to immerse the retaining layer in the additive or inject the additive into the retaining layer because an amount of the additive can be adjusted.

(Repair Sheet with Supporting Layer)

A repair sheet provided with a supporting layer can be produced by adhering a retaining layer before provided with the supporting layer to the supporting layer. The adhesion is not particularly limited, regardless of the means used, as long as the retaining layer before provided with the supporting layer and the supporting layer can be adhered with an adhesive force equal or greater than a necessary minimum adhesive force. For example, if the two layers are adhered as they are, the adhesion can be performed in this way, or if necessary, it can be performed by using a suitable adhesive. However, if the supporting layer is to be separated during use, the adhesion is preferably an adhesion with an adhesive force within a range that allows easy separation. Besides, a “necessary minimum adhesive force” refers to an adhesive force necessary for the supporting layer and the retaining layer to adhere from the time the supporting layer is adhered to the retaining layer until the supporting layer is peeled off from the repair sheet.

### Tire Repairing Method

The tire repairing method of the present disclosure is a tire repairing method comprising the steps of attaching the repair sheet to a tire part and supplying the additive into the tire part.

The tire repairing method of the present disclosure can be performed by attaching the repair sheet directly to an externally exposed part of a tire part, such as, for example, a tread part, a sidewall part, a clinch part, a wing part on the outer surface, an inner liner part on the inner surface, and the like. In this case, since the repair sheet has predetermined breaking strength and breaking elongation, it can be efficiently attached to the tire. Moreover, an amount of an additive to be supplied to the tire can be adjusted by a time for which the repair sheet retaining the additive is brought into contact with the tire, i.e., a repairing time, as well as by an amount of an additive retained in the repair sheet. Accordingly, the tire can be processed with less effort.

Besides, the above-described descriptions regarding the repair sheet can also be applied to the descriptions of the repairing method unless there is any particular contradiction.

### Application

The repair sheet of the present disclosure can be used for repair of a tire used in a wide variety of vehicles such as a passenger car, a large vehicle such as a truck, a bus, etc., a motorcycle, a racing vehicle, an industrial vehicle, a special vehicle, a load vehicle such as a trailer, a trolley, etc., and the like. Moreover, such a tire is not limited to a pneumatic tire, and may be a non-pneumatic tire. In particular, in a studless tire, a larger amount of additives are compounded compared with a normal tire in order to obtain a grounding surface effect and an edge effect on icy and snowy roads, so hardening of the rubber easily progresses over time, and therefore, the repair sheet of the present disclosure can be appropriately used. Tire parts to which the repair sheet of the present disclosure is applied are not particularly limited, but are generally a tread part, a sidewall part, a clinch part, a wing part, an inner liner part, etc. that constitute a surface including an outer surface or an inner surface of the tire, in particular, the repair sheet can be appropriately applied to the tread part.

### EXAMPLE

Hereinafter, the present invention will be described based on Examples, though the present invention is not limited to these Examples.

Materials used in Examples and Comparative examples are collectively shown below.
Thermoplastic elastomer: Tuftec (Registered Trademark) P1500 manufactured by Asahi Kasei Corporation (hydrogenated styrene-based thermoplastic elastomer, styrene-ethylene-butylene-styrene block copolymer (SEBS), styrene/ethylene-butylene-butadiene ratio: 30/70)
First resin: Asaflex (Registered Trademark) 815 manufactured by Asahi Kasei Corporation (styrene-based resin, styrene-butadiene copolymer resin (SBC), tensile strength (50 mm/min): 27MPa, Vicat softening temperature: 82° C.)
Crosslinked rubber: Crosslinked rubber obtained in Production example 1 below
Oil: PS-32 manufactured by Idemitsu Kosan Co., Ltd. (mineral oil). Second resin: NOVARES C10 manufactured by Rutgers Chemicals (liquid coumarone indene resin)
Ester-based plasticizing agent: Bis(2-ethylhexyl)sebacate (dioctyl sebacate) manufactured by DAIHACHI CHEMICAL INDUSTRY CO., LTD.
Antioxidant: Nocrac 6C manufactured by Ouchi Shinko Chemical Industry Co., Ltd. (N-(1,3-dimethylbutyl)-N′-phenyl-p-phenylenediamine)

### Experiment Example 1

### <Repair Sheet>

### (Retaining Layer 1)

A pelletized thermoplastic elastomer was pressed using a press molding machine for rubber under a condition at 170° C. for 5 minutes with 1 MPa to produce a retaining layer 1 that is a repair sheet. The retaining layer 1 thus obtained was cut into a size of 20 mm in vertical (tire width direction)×30 mm in lateral (tire circumferential direction)×2 mm in thickness.

### (Retaining Layer 2)

A pelletized first resin was pressed using a vacuum press molding machine under a condition at 140° C. for 5 minutes with 10 MPa to produce a retaining layer 2 that is a repair sheet. The retaining layer 2 thus obtained was cut into a size of 20 mm in vertical (tire width direction)×30 mm in lateral (tire circumferential direction)×2 mm in thickness.

### (Retaining Layer 3)

A crosslinked rubber was pressed using a vulcanization press molding machine for rubber under a condition at 170° C. for 20 minutes with 10 MPa to produce a retaining layer 3 that is a repair sheet. The retaining layer 3 thus obtained was cut into a size of 20 mm in vertical (tire width direction)×30 mm in lateral (tire circumferential direction)×2 mm in thickness.

Breaking strength and breaking elongation of the retaining layer 1, the retaining layer 2, and the retaining layer 3 obtained above were measured as follows. The results are shown in Table 1.

### (Breaking Strength, Breaking Elongation)

A dumbbell-shaped No. 7 test piece with a thickness of 1 mm was prepared which was cut out so that lateral directions (tire circumferential directions) of the retaining layer 1, the retaining layer 2, and the retaining layer 3 become tensile directions, and according to JIS K 6251 “Rubber, vulcanized or thermoplastics-Determination of tensile stress-strain properties”, a tensile test was performed under a condition of a tensile speed of 3.3 mm/sec in an atmosphere of 23° C. to measure breaking strength (TB) and breaking elongation (EB) (%).

TABLE 1

| | Breaking strength (MPa) | Breaking elongation (%) |
|---|---|---|
| Retaining layer 1 | 3 | 700 |
| Retaining layer 2 | 18 | 230 |
| Retaining layer 3 | 17 | 420 |

### <Repair Sheet Retaining Additive>

Using the retaining layer 1, the retaining layer 2, or the retaining layer 3, which is the repair sheet obtained above, immersion was performed with additives under immersion conditions shown in Table 2 below to produce repair sheets 1 to 10 in which the additives were retained in ratios shown in

Table 2.

TABLE 2

| | | | | Ratio of |
|---|---|---|---|---|
| | | | | additive |
| | Retaining | | Immersion | (% by |
| | layer | Additive | condition | mass) |
| Repair sheet 1 | 1 | Oil | 60° C., 4 hours | 40 |
| Repair sheet 2 | 1 | Oil | 60° C., 24 hours | 60 |
| Repair sheet 3 | 1 | Second resin | 60° C., 24 hours | 60 |
| Repair sheet 4 | 1 | Ester-based | 60° C., 24 hours | 60 |
| | | plasticizing | | |
| | | agent | | |
| Repair sheet 5 | 1 | Antioxidant | 60° C., 4 hours | 40 |
| Repair sheet 6 | 1 | Antioxidant | 60° C., 24 hours | 60 |
| Repair sheet 7 | 2 | Oil | 60° C., 4 hours | 20 |
| Repair sheet 8 | 2 | Oil | 60° C., 24 hours | 40 |
| Repair sheet 9 | 3 | Oil | 60° C., 4 hours | 15 |
| Repair sheet 10 | 3 | Oil | 60° C., 24 hours | 30 |

### <Tire Repair>

A used tire 0 and used tires 1 to 3 (any of which are WINTER MAXX 02 manufactured in 2018 (by Sumitomo Rubber Industries, Ltd.); 2-year running products; same stencil) were prepared. These tires were all installed on the same vehicle. Among them, the used tire 0 was used for Comparative examples, and the used tires 1 to 3 were used for Examples. As shown in Table 3, the used tire 0 in Comparative example was directly sent for tire evaluation without any repairs. On the other hand, the used tires 1 to 3 in

Examples were repaired at a room temperature (25° C.) under conditions shown in Table 3, and then sent for tire evaluation.

<Evaluation on Tire>Each tire was evaluated as follows. The results are shown in Table 3.

### (Content of Additive)

A content of an additive was determined as an amount of an extract by immersing a sample cut out from a tread surface of each tire in acetone for 24 hours to extract a soluble component and measuring masses of each sample before and after extraction, according to JIS K 6229, with the following equation. The content was indicated as an index with the amount of the extract (%) in Comparative example 1 being as 100. The higher the numerical value is, the greater the amount of the extract, i.e., the content of the additive is.

Amount of extract (%)={(mass of sample before extraction−mass of sample after extraction)/(mass of sample before extraction)}×100.

### (Hardness)

A sample for measuring hardness was cut out from a tread part forming a grounding surface of each tire so that a tire radial direction became a thickness direction, and a type A durometer was pressed against the sample from the grounding surface side at 23° C. to measure a rubber hardness in accordance with JIS K 6253. An inverse value of the hardness was indicated as an index with the case of Comparative example 1 being as 100. The higher the numerical value is, the lower the hardness is and the softer the rubber is.

### (Wet Grip Performance and On-Ice Performance)

Regarding wet grip performance, a coefficient of road friction was measured using an inside drum testing machine at a drum speed of 20 km/h under a wet road surface condition (25° C., 5 mm of water depth) with a slip ratio changed from 0 to 30%. The coefficient of road friction thus obtained was indicated as an index (wet grip performance index) with the case of Comparative example 1 being as 100. The higher the numerical value is, the higher the wet grip performance is.

Regarding on-ice performance, the same measurement was performed as for the wet grip performance index, except that a frozen road surface condition (-1° C., on ice) was used instead of the wet road surface condition, to obtain an on-ice performance index. The higher the numerical value is, the higher the on-ice performance is.

TABLE 3

| | Comparative | Example | Example | Example |
|---|---|---|---|---|
| | example 1 | 1 | 2 | 3 |
| Tire | Used | Used | Used | Used |
| | tire 0 | tire 1 | tire 2 | tire 3 |
| Repair sheet 1 | — | Used | Used | — |
| Retaining layer | | Retaining | Retaining | |
| | | layer 1 | layer 1 | |
| Additive | | Oil | Oil | |
| Ratio of additive | | 40 | 40 | |
| (% by mass) | | | | |
| Repair sheet 2 | — | — | — | Used |
| Retaining layer | | | | Retaining |
| | | | | layer 1 |
| Additive | | | | Oil |
| Ratio of additive | | | | 60 |
| (% by mass) | | | | |
| Repairing time (day) | — | 3 | 7 | 3 |
| Content of additive | 100 | 193 | 242 | 387 |
| (index) | | | | |
| Hardness (index) | 100 | 118 | 127 | 132 |
| Wet grip performance | 100 | 105 | 106 | 107 |
| (index) | | | | |
| On-ice performance | 100 | 120 | 123 | 125 |
| (index) | | | | |

As is clear from Table 3, as a result of the repair, in Examples, a content of an additive in a tread part was increased, hardness of the tread part was decreased to soften the tread part, and further, wet grip performance and on-ice performance were improved, compared to Comparative example.

### Experiment Example 2

The same procedure was conducted as for Experiment example 1, except that a used tire 4 and a used tire 5 (any of which are WINTER MAXX 02 manufactured in 2018 (by Sumitomo Rubber Industries, Ltd.); 2-year running products; same stencil) were prepared as tires to be used for repair, that a second resin and an ester-based plasticizing agent were used as additives retained in the retaining layer 1, and that the procedure was conducted in accordance with Table 4, to obtain results regarding Examples 4 and 5.

TABLE 4

| | Comparative | Example | Example |
|---|---|---|---|
| | example 1 | 4 | 5 |
| Tire | Used tire 0 | Used tire 4 | Used tire 5 |
| Repair sheet 3 | — | Used | — |
| Retaining layer | | Retaining | |
| | | layer 1 | |
| Additive | | Second resin | |
| Ratio of additive (% by mass) | | 60 | |
| Repair sheet 4 | — | — | Used |
| Retaining layer | | | Retaining |
| | | | layer 1 |
| Additive | | | Ester-based |
| | | | plasticizing |
| | | | agent |
| Ratio of additive (% by mass) | | | 60 |
| Repairing time (day) | — | 3 | 3 |
| Content of additive (index) | 100 | 370 | 350 |
| Hardness (index) | 100 | 133 | 129 |
| Wet grip performance (index) | 100 | 107 | 106 |
| On-ice performance (index) | 100 | 126 | 125 |

As is clear from Table 4, as a result of the repair, in Examples, a content of an additive in a tread part was increased, hardness of the tread part was decreased to soften the tread part, and further, wet grip performance and on-ice performance were improved, compared to Comparative example.

### Experiment Example 3

The same procedure was conducted as for Experiment example 1, except that used tires 6 to 8 (any of which are WINTER MAXX 02 manufactured in 2018 (by Sumitomo Rubber Industries, Ltd.); 2-year running products; same stencil) were prepared as tires to be used for repair, that an antioxidant was used as an additive retained in the retaining layer 1, that ozone resistance was evaluated, and that the procedure was conducted in accordance with Table 5, to obtain results regarding Examples 6 to 8.

### (Ozone Resistance)

Ozone resistance was evaluated by preparing a test piece of a predetermined size from a surface of a tread part and performing a dynamic ozone deterioration test for this test piece, in accordance with JIS K 6259 “Rubber, vulcanized or thermoplastics-Determination of ozone resistance”.

Specifically, a test of imparting with 48 hours of reciprocating motion at a frequency of 0.5+0.025Hz for the test piece was performed under a condition of an ozone concentration of 50+5pphm, a test temperature at 40° C., and a tensile strain of 10+2%, and after the test, states of cracks (presence or absence of cracks, number of cracks, lengths of cracks, etc.) generated on the test piece were observed. As an evaluation method, the method described in JIS K 6259 (Procedure A: Crack condition observation procedure) was used. Specifically, a numerical value indicating a degree of crack generation defined by multiplying the number of cracks of 0.05 mm or more confirmed after the test by an average length of cracks of 0.05 mm or more in length was calculated, and an inverse value of the numerical value was used as an evaluation value of an ozone resistance index. Therefore, it can be said that the higher the numerical value is than the ozone resistance index of 100 in Comparative example 2 which is the evaluation standard, the less cracks are generated and the smaller the sizes of cracks become, indicating that ozone resistance is excellent.

TABLE 5

| | Comparative | Example | Example | Example |
|---|---|---|---|---|
| | example 1 | 6 | 7 | 8 |
| Tire | Used | Used | Used | Used |
| | tire 0 | tire 6 | tire 7 | tire 8 |
| Repair sheet 5 | — | Used | Used | — |
| Retaining layer | | Retaining | Retaining | |
| | | layer 1 | layer 1 | |
| Additive | | Anti- | Anti- | |
| | | oxidant | oxidant | |
| Ratio of additive | | 40 | 40 | |
| (% by mass) | | | | |
| Repair sheet 6 | — | — | — | Used |
| Retaining layer | | | | Retaining |
| | | | | layer 1 |
| Additive | | | | Anti- |
| | | | | oxidant |
| Ratio of additive | | | | 60 |
| (% by mass) | | | | |
| Repairing time (day) | — | 3 | 7 | 3 |
| Content of additive | 100 | 108 | 113 | 116 |
| (index) | | | | |
| Ozone resistance | 100 | 115 | 132 | 135 |
| (index) | | | | |

As is clear from Table 5, as a result of the repair, in Examples, a content of an additive in a tread part was increased, and ozone resistance of the tread part was improved, compared to Comparative example.

### Experiment Example 4

The same procedure was conducted as for Experiment example 1, except that used tires 9 to 11 (any of which are WINTER MAXX 02 manufactured in 2018 (by Sumitomo Rubber Industries, Ltd.); 2-year running products; same stencil) were prepared as tires to be used for repair, that a retaining layer 2 was used as a retaining layer, and that the procedure was conducted in accordance with Table 6, to obtain results regarding Examples 9 to 11.

TABLE 6

| | Comparative | Example | Example | Example |
|---|---|---|---|---|
| | example 1 | 9 | 10 | 11 |
| Tire | Used | Used | Used | Used |
| | tire 0 | tire 9 | tire 10 | tire 11 |
| Repair sheet 7 | — | Used | Used | — |
| Retaining layer | | Retaining | Retaining | |
| | | layer 2 | layer 2 | |
| Additive | | Oil | Oil | |
| Ratio of additive | | 20 | 20 | |
| (% by mass) | | | | |
| Repair sheet 8 | — | — | — | Used |
| Retaining layer | | | | Retaining |
| | | | | layer 2 |
| Additive | | | | Oil |
| Ratio of additive | | | | 40 |
| (% by mass) | | | | |
| Repairing time | — | 3 | 7 | 3 |
| (day) | | | | |
| Content of additive | 100 | 150 | 160 | 180 |
| (index) | | | | |
| Hardness (index) | 100 | 112 | 114 | 119 |
| Wet grip | 100 | 102 | 103 | 104 |
| performance (index) | | | | |
| On-ice performance | 100 | 105 | 108 | 110 |
| (index) | | | | |

As is clear from Table 6, as a result of the repair, in Examples, a content of an additive in a tread part was increased, hardness of the tread part was decreased to soften the tread part, and further, wet grip performance and on-ice performance were improved, compared to Comparative example.

### Experiment Example 5

Used tires 12 to 15 (any of which are WINTER MAXX 02 manufactured in 2018 (by Sumitomo Rubber Industries, Ltd.); 2-year running products; same stencil) were prepared as tires to be used for repair. These tires were all installed on the same vehicle. The same procedure was conducted as for Experiment example 1, except that a used tire 12 was used in Comparative example, that used tires 13 to 15 were used in Examples, that a retaining layer 3 was used as a retaining layer, and that the procedure was conducted in accordance with Table 7, to obtain results regarding Examples 12 to 14.

TABLE 7

| | Comparative | Example | Example | Example |
|---|---|---|---|---|
| | example 2 | 12 | 13 | 14 |
| Tire | Used | Used | Used | Used |
| | tire 0 | tire 12 | tire 13 | tire 14 |
| Repair sheet 9 | — | Used | Used | — |
| Retaining layer | | Retaining | Retaining | |
| | | layer 3 | layer 3 | |
| Additive | | Oil | Oil | |
| Ratio of additive | | 15 | 15 | |
| (% by mass) | | | | |
| Repair sheet 10 | — | — | — | Used |
| Retaining layer | | | | Retaining |
| | | | | layer 3 |
| Additive | | | | Oil |
| Ratio of additive | | | | 30 |
| (% by mass) | | | | |
| Repairing time (day) | — | 3 | 7 | 3 |
| Content of additive | 100 | 120 | 130 | 150 |
| (index) | | | | |
| Hardness (index) | 100 | 104 | 107 | 113 |
| Wet grip performance | 100 | 101 | 101 | 102 |
| (index) | | | | |
| On-ice performance | 100 | 103 | 104 | 106 |
| (index) | | | | |

As is clear from Table 7, as a result of the repair, in Examples, a content of an additive in a tread part was increased, hardness of the tread part was decreased to soften the tread part, and further, wet grip performance and on-ice performance were improved, compared to Comparative example.

### Production Example 1

A crosslinked rubber was produced according to the compounding shown in Table 8. That is, among the components listed in table 8, rubbers other than sulfur and vulcanization accelerators were kneaded, and then sulfur 10 and vulcanization accelerators were added to the kneaded product, which was further kneaded to obtain a kneaded product. For kneading, a general closed type kneader for rubber kneading and two rolls were used. The kneaded product was vulcanized at 170° C. for 20 minutes to obtain a crosslinked rubber composition.

TABLE 8

| | | Compounding |
|---|---|---|
| | | amount |
| Component | | (% by mass) |
| SBR | Nipol 1502 manufactured by Zeon | 100 |
| | Corporation | |
| Carbon black | Seast 6, by TOKAI CARBON CO., | 20 |
| | LTD. | |
| Stearic acid | Stearic acid “CAMELLIA” | 2 |
| | manufactured by NOF | |
| | CORPORATION | |
| Zinc oxide | Zinc oxide No. 2 manufactured by | 2 |
| | HAKUSUI TECH CO., LTD. | |
| Sulfur | “GOLDEN FLOWER” 5% oil sulfur | 1.5 |
| | manufactured by Tsurumi Chemical | |
| | Industry Co., Ltd. | |
| Vulcanization | Nocceler CZ-G manufactured by Ouchi | 2.5 |
| accelerator 1 | Shinko Chemical Industry Co., Ltd. | |
| Vulcanization | Nocceler D manufactured by Ouchi | 1 |
| accelerator 2 | Shinko Chemical Industry Co., Ltd. | |

### Embodiment

Examples of embodiments of the present disclosure are shown below.

[1] A repair sheet to be attached to a tire part, the repair sheet comprising
a retaining layer capable of retaining an additive to be supplied into the tire part,
wherein the retaining layer has a breaking strength of 0.5 MPa or more, preferably greater than 0.5 MPa, more preferably greater than 1.0 MPa, further preferably greater than 1.5 MPa, further preferably greater than 2.0 MPa, further preferably 3.0 MPa or more, further preferably greater than 5.0 MPa, further preferably greater than 10.0 MPa, further preferably greater than 15.0 MPa, further preferably 17.0 MPa or more, and a breaking elongation of 5% or more, preferably greater than 5%, more preferably is greater than 10%, more preferably greater than 50%, further preferably greater than 100%, further preferably greater than 200%, further preferably 230% or more, further preferably greater than 300%, further preferably greater than 400%, further preferably 420% or more, further preferably greater than 500%, further preferably greater than 600%.

[2] The repair sheet of [1] above, wherein the retaining layer comprises at least one selected from the group consisting of a thermoplastic elastomer, a resin, and a crosslinked rubber.

[3] The repair sheet of [1] or [2] above, wherein a thickness of the retaining layer is 100 mm or less, preferably 80 mm or less, more preferably 60 mm or less, further preferably 50 mm or less.

[4] The repair sheet of any one of [1] to [3] above, further comprising a supporting layer that supports the retaining layer.

[5] The repair sheet of any one of [1] to [4] above, wherein the additive is retained in the retaining layer.

[6] The repair sheet of [5] above, wherein the additive comprises at least one selected from the group consisting of a plasticizing agent, an antioxidant, and a vulcanization accelerator. [7] A tire repairing method, the repairing method comprising the steps of:
attaching the repair sheet of [5] or [6] above to a tire part, and
supplying the additive into the tire part.

[8] The repairing method of [7] above, wherein the retaining layer has a vertical length equal to or less than a tire width plus 10 mm, a lateral length equal to or less than a tire periphery plus 10 mm, and a thickness of 110 mm or less, and
wherein the tire part is a tread part of the tire.

1. A repair sheet to be attached to a tire part, the repair sheet comprising
a retaining layer capable of retaining an additive to be supplied into the tire part,
wherein the retaining layer has a breaking strength of 0.5 MPa or more and a breaking elongation of 5% or more.

2. The repair sheet of claim 1, wherein the retaining layer comprises at least one selected from the group consisting of a thermoplastic elastomer, a resin, and a crosslinked rubber.

3. The repair sheet of claim 1 or 2, wherein a thickness of the retaining layer is 100 mm or less.

4. The repair sheet of any one of claims 1 to 3, further comprising a supporting layer that supports the retaining layer.

5. The repair sheet of any one of claims 1 to 4, wherein the additive is retained in the retaining layer.

6. The repair sheet of claim 5, wherein the additive comprises at least one selected from the group consisting of a plasticizing agent, an antioxidant, and a vulcanization accelerator.

7. A tire repairing method, the repairing method comprising the steps of:
attaching the repair sheet of claim 5 or 6 to a tire part, and supplying the additive into the tire part.

8. The repairing method of claim 7, wherein the retaining layer has a vertical length equal to or less than a tire width plus 10 mm, a lateral length equal to or less than a tire periphery plus 10 mm, and a thickness of 110 mm or less, and
wherein the tire part is a tread part of the tire.
